(19) United States
(12) Patent Application Publication
(10) Pub. No.: US 2008/0281832 A1
(43) Pub. Date: Nov. 13, 2008

(54) SYSTEM AND METHOD FOR PROCESSING REALLY SIMPLE SYNDICATION (RSS) FEEDS

(76) Inventors: Jeffrey L. Pulver, Great Neck, NY (US); James R. Marcus, New Canaan, CT (US); Suman Roy, New York, NY (US); Matthew Stokes, Brooklyn, NY (US); Dmitry V. Yashin, Old Westbury, NY (US)

Correspondence Address: PILLSBURY WINTHROP SHAW PITTMAN, LLP, P.O. BOX 10500, MCLEAN, VA, 22102, US

(21) Appl. No.: 11/745,819

(22) Filed: May 8, 2007

(51) Int. Cl. G06F 7/00; G06F 17/00

(52) U.S. Cl. 707/100; 715/205; 715/234; 707/E17.123

(57) ABSTRACT

The invention provides a system and method for acquiring, normalizing, indexing and storing information related to RSS feeds and their constituent content items in a searchable database. In some embodiments, the invention includes an application that accesses electronic feed documents for a plurality of RSS feeds to ascertain information regarding the feed and content items within the feed. The information is then parsed to identify characteristics of the feeds and their content items. The characteristics of the feeds and content items can then be stored in a common format in a database. This enables, inter alia, creation of custom feeds by utilizing the normalized feed data.

### FIELD OF THE INVENTION

The invention relates to a system and method for normalization and aggregation of information regarding really simple syndication (RSS) feeds and associated content.

### BACKGROUND OF THE INVENTION

Really simple syndication (RSS, also known as RDF [resource description framework] Site Summary, or Rich Site Summary), provides a lightweight method for publishing content on the World Wide Web. RSS feeds typically include a news or other content provider maintaining an XML document that provides addresses (e.g., URLs) for distinct items of content. Users may “subscribe” to a feed by instructing an RSS reader (a software application) to check the XML document (a.k.a. the “feed”) for content items at a predetermined interval. The RSS reader then enables the user to view any of the content items listed on the feed by connecting to the web page(s) associated with the addresses upon user selection. If new content items are added by the content service, the XML document (“feed”) is updated with information relating to the new content items and an address for web pages of the new content items. The next time a user's RSS reader checks the feed, the new content items are presented and accessible to the user.

Content providers such as, for example, news and entertainment outlets tend to produce content items that cover a variety of topics. While some content providers may specialize in certain topics and some content providers may provide separate feeds for different authors or topics, not all of the content items for a specialist content provider or specialist feed deal with the topics or subtopics that may interest a particular user. As it may not be desirable for a user interested in a handful of topics to manually search through content items of various feeds looking for items and media most relevant to their interest, there is a need for a system to search across RSS feeds to selectively filter content items and media according to customized topics or other parameters.

An obstacle to selective filtering of RSS feeds is the fact that RSS is a relatively “un-standardized” standard. For example, some RSS standards include RSS 1.0, RSS 2.0, Atom, and others. Furthermore, there are different media enclosed in different RSS feeds, different tags and syntax are used to represent characteristics of content items and media. Other differences also exist.

As such, there is a need for a system for analyzing, tagging, and cataloguing RSS content of disparate formats into a normalized, searchable database.

### SUMMARY OF THE INVENTION

The invention solving these and other problems relates to a system and method for acquiring, normalizing, and indexing information regarding RSS fees and their constituent content items into a searchable database. The searchable database may then be used, for example, by users to filter and/or aggregate content items from multiple disparate feeds into custom feeds based on the indexed information.

In some embodiments, the invention may include a feed collection application that acquires information regarding individual RSS information feeds, normalizes the information and stores it in a searchable database. Users or other entities may then view, search, or otherwise access the normalized information. In one embodiment, users may aggregate feeds and/or individual content items therefrom, based on characteristics of the feeds such as, for example, standard attributes of the feed, user/administrator applied attributes, or other characteristics. This enables users to uniquely associate feeds and/or content items based on the characteristics of the feeds, for example, by topic. In some embodiments, the feed collection application may be a web-based application accessible by users via the Internet or other network.

In some embodiments, the feed collection application includes a graphical user interface that displays a list of abbreviated content items (e.g., titles and first line of text) grouped by each available topic. Each item in the list my be a hyperlink to the content items listed. Thus, the application does not republish any content, but always refers back to the original source of information, e.g., the URL provided by the content provider of the feed. In some embodiments, the listed content items may be grouped via a characteristic other than topic (e.g., author, feed of origin, or other characteristic) when displayed by the graphical user interface. In some embodiments, the characteristics by which the content items are displayed my be chosen/manipulated by an administrator, a user, or other entity. Because all of the information regarding feeds and/or content items is normalized before storage into the searchable database of the invention, the search, display, and/or other manipulation or use of information from multiple disparate feeds is not hindered by syntax, format, or other differences.

In some embodiments, the feed collection application intelligently parses individual RSS feeds. This may include recognizing embedded multimedia objects (also known as enclosures) such as, for example, images, audio, and video files. Recognized embedded multimedia objects may then be displayed or otherwise made available to users, for example, along with their content items of origin or as content items themselves.

These and other objects, features, and advantages of the invention will be apparent through the detailed description and the drawings attached hereto. It is also to be understood that both the foregoing summary and the following detailed description are exemplary and not restrictive of the scope of the invention.

### BRIEF DESCRIPTION OF THE DRAWINGS

FIG. 1 illustrates an example of a system for acquiring, normalizing, indexing, and providing a searchable database of RSS feed information according to various embodiments of the invention.

FIG. 2 illustrates an example of a method for constructing a searchable database of normalized information regarding RSS feeds according to various embodiments of the invention.

FIG. 3 illustrates an example of the operation of components of a system for acquiring normalizing, indexing, and providing a searchable database of RSS feed information according to various embodiments of the invention.

FIG. 4 illustrates an example of a process for indexing, aggregating and/or accessing RSS feeds and their content items according to various embodiments of the invention.

### DETAILED DESCRIPTION

The invention provides a system and method for acquiring, normalizing, and indexing characteristic information related to RSS feeds and their content items in a searchable database. The invention enables search, filtering, custom aggregation, and other features for RSS feeds having disparate formats.

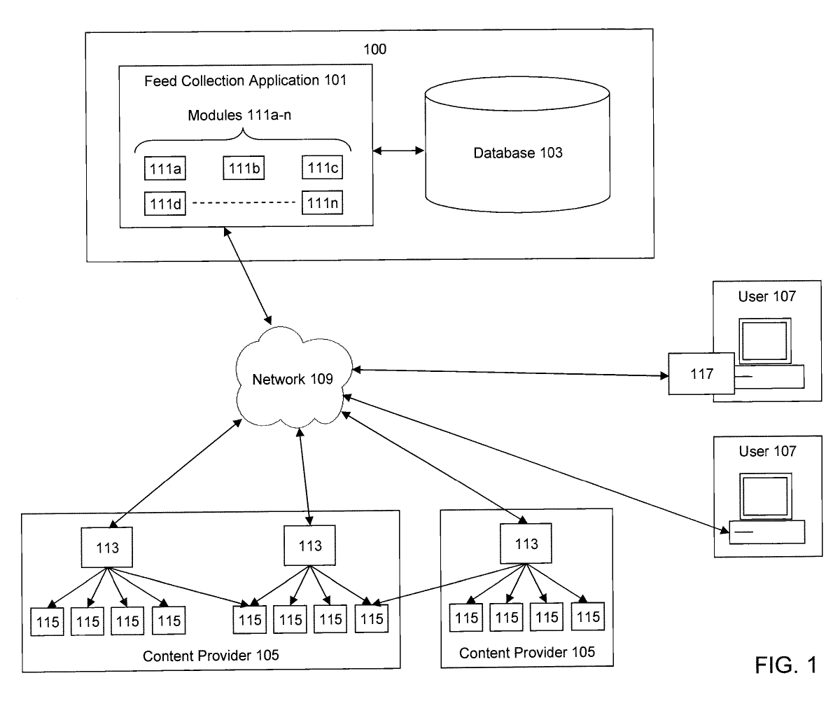

FIG. 1 illustrates a system 100, which is an example of a system for acquiring, normalizing, indexing, and providing a searchable database of RSS feed information or other news, blog, or other feed information (collectively referred to as RSS feed information), including information regarding the constituent content items of RSS feeds.

System 100 may include a feed collection application 101, a database 103, and/or other elements. System 100 may interface with content providers 105, users 107, or other systems or entities via network 109. Network 109 may include, for example, the Internet, or other computer network. In one embodiment, administrators, users 107, or other entities may access or interface with control application 101 through an interface of system 100 such as, for example a graphical user interface supported by feed collection application 101.

In some embodiments, feed collection application 101 may comprise an Internet web site, an intranet site, or other host site or computer application maintained on system 100. Accordingly, one or more hardware devices such as, for example, servers, memory devices, or other devices, may be included in system 100 to support feed collection application 101, database 103, and/or other features and functions of the invention.

Feed collection application 101 may include one or more software modules 111a-n for identifying/specifying feeds from which information is to be gathered, scanning feeds via their electronic feed documents to acquire information regarding feeds and content items of the feeds, normalizing the acquired feed information, storing the normalized feed information in a searchable database (e.g., database 103), associating custom characteristics or other information with the normalized feed information stored in database 103, querying or otherwise manipulating the normalized feed information, creating customized aggregated feeds, presenting the feed information to users 107 or other entities, or for performing any of the other various operations described in herein.

In particular, control application 101 may comprise a scanning module 111a for reading and parsing electronic feed documents 113, a processing module 111b for normalizing feed and content item information and otherwise processing feed and content information, a query/filter module 111c for selectively accessing feed and content items information stored in database 103, an interface module 111d for providing various graphical user interfaces or other interfaces to system 100, and/or other modules 111n for performing any of the features or functions of the inventions described herein. One or more of the modules comprising control application 101 may be combined. For some purposes, not all modules may be necessary.

Content providers 105 may provide one or more RSS feeds. Each RSS feed may include an electronic feed document 113. Electronic feed documents 113 are electronic documents maintained by or on behalf of content providers 105 and that are accessible via network 109, for example, using a URL or other address associated with an electronic feed document 113. Electronic feed documents 113 provide a “feed” of content items 115 to a feed reader or other interface. As illustrated in FIG. 1, content providers 105 may support multiple feeds. For example, a news organization may support dozens of feeds covering various categories based on subject matter, author, or other characteristics (e.g., a feed for world news, a feed for local news, a feed for a particular columnist, etc.). In some instances, multiple feeds may include or “point to” the same content item 115, especially when their respective categories overlap. In some instances, feeds may include or point to content items 115 that are hosted by other content providers 105 or other entities.

Electronic feed documents 113 include information relating to each of the one or more of the content items 115 available via a feed. As described above, the invention acquires and normalizes information from electronic feed documents 113 that may have disparate formats to provide a filterable and searchable database of feed information from disparate sources. The information regarding content items 115 included in an Electronic feed document 113 may include, for example, a title for the content item, the publication date of a content item, the publication time of the content item, the author of the content item, a topic or category that the content item falls under, a summary and/or description of the content item, a first sentence of the content item, any enclosures associated with the content item (e.g., any media, such as, image files, video files, audio files, flash files, or other multimedia items), and/or other information. Electronic feed documents 113 may also include information relating to the feed itself such as, for example, feed title, a content source for the feed (e.g., an identity of a content provider 105), the feed's author (if any), content description for the feed, a date/time of last update, and/or other information. In some instances, electronic feed documents 113 are XML documents, but may include other formats. In some embodiments, the invention provides, via “custom processing” (described below), the ability to associate additional characteristics with a feed or content item when that characteristic is not included in an electronic feed document 113.

An electronic feed document 113 may also include a pointer to each of the one or more electronic content items 115 available via the feed. The pointer may be in the form of a URL, IP address, or other address where the content item 115 can be found.

In some instances, feed information may be referred to as “channel information.” However, those having skill in the art will appreciate that a channel and a feed essentially describe the same thing: an index of content items as represented by an electronic feed document 113. As such, channel information and feed information may both refer to the information/meta data for a given feed and information/meta data for the various content items 115 of the given feed.

Users 107 may utilize network 109 to access/interact with system 100 and content providers 105. Users may utilize network 109 using computer implemented devices such as, for example, desktop computers, laptop computers, personal digital assistants (PDAs), handheld computers, cell phones, smart phones, or other computer-implemented devices. Users 107 may utilize a feed reader or other interface to access feeds (e.g., electronic feed documents 113 and content items 115). Feed readers or other interfaces used to access feeds and their content items may include local applications or modules (e.g., interface 117) that reside on a user 107's system or may be thin client applications that users 107 can access via network 109. As such, these thin client feed readers or interfaces may reside or otherwise be supported by system 100 (e.g., the thin client feed reader may be supported by interface module 111d or other module of feed collection application 101) or may be supported by or reside on a system of another party. In some embodiments, a combination of local and thin-client resources may be used to provide an interface to access electronic feed documents 113 and content items 115.

The feed reader or other interface accesses electronic feed document 113 and displays the feed and content item information as included on electronic feed document 113. When a user wishes to view or otherwise access a content item 115, the feed reader or other interface uses the URL or other address for the specific content item 115 provided by the electronic feed document 113 to direct the feed reader or other interface to the content item 115 as stored by or on behalf of content provider 105.

Those having skill in the art will appreciate that the invention described herein may work with various system configurations. Accordingly, more or less of the aforementioned system components may be used and/or combined in various embodiments. In some embodiments, as would be appreciated, the functionalities described herein may be implemented in various combinations of hardware and/or firmware, in addition to, or instead of, software.

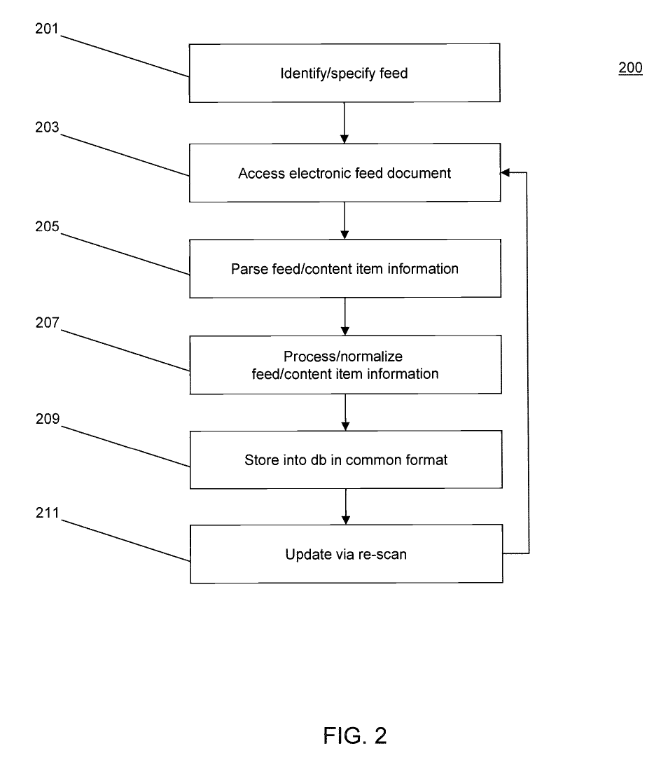

FIG. 2 illustrates a method 200, which is an example of a method according to the invention for constructing a searchable database (e.g., database 103) of normalized information regarding RSS feeds and information regarding content items of RSS feeds.

Method 200 includes an operation 101, wherein RSS feeds are identified and specified for inclusion to the database (e.g., database 103). Feeds may be specified in different ways by various entities such as, for example, administrators, users, or other entities. For example, in some embodiments, a predetermined set of feeds my be specified by an administrator. In other instances, feeds may be specified for inclusion to database 103 by users 107 or other entities.

One or more feeds may be specified by an administrator, user 107, or other entity by explicitly entering a URL or other address for the electronic feed documents 113 of the one or more feeds into a graphical user interface supported by one or more modules 111a-n (e.g., interface module 111d) of feed collection application 101. In some embodiments, one or more feeds may be specified for inclusion into database 103 by uploading or otherwise providing an OPML (Outline Processor Markup Language) file, or other file format readable by the application, that includes the URLs or other addresses of the electronic feed documents 113 of the one or more feeds. In some embodiments, users 107, administrators, or other entities may perform searches such as, for example, topic searches or other searches, to identify feeds for inclusion into database 103 and then specify that these feeds for inclusion into database 103.

The identified feeds may then be scanned to identify the feed information and content item information for inclusion into database 103. The scanning or information acquisition operations may utilize, for example, one or more modules 111a-n (e.g., scanning module 111a) of feed collection application 101. In some embodiments, the scanning module may include, for example, a PHP library called MagpieRSS (http://magpierss.sourceforge.net/). Other libraries or modules may be used.

In an operation 203, the scanning module may access an electronic feed document 113 of an RSS feed using the URL address or other address of the electronic feed document 113.

In an operation 205, scanning module 111a may then read and parse the information relating to the feed and its content items 115 from electronic feed document 113 into an array of tags and their corresponding values. Each tag identifies a characteristic of the feed or content item 115. The values of the tags represent the specific instance of the particular characteristic. For example, a given tag for a content item 115 of a feed may be an “author” tag. A value or specific instance of the “author” tag for the specific content item 115 may include “John Doe.” Feed characteristics represented as tags and values may include, for example, feed title, a content source for the feed (e.g., the identity of a content provider 105), the feed's author (if any), content description for the feed, date/time of last update, and/or other information. Content item characteristics may include, for example, the title of the content item, the publication date of a content item, the publication time of the content item, the author of the content item, a topic or category the item falls under, a summary and/or description of the content item, a first sentence of any text of a content item, any enclosures comprising or associated with the content item (e.g., any media, such as, image files, video files, audio files, flash files, or other multimedia items), a pointer or address for a contact item (e.g., URL), and/or other information. Other tags and values may be used.

Feeds may be scanned in different manners. In some embodiments, scanning module 111a may scan single feeds. In these instances, a single electronic feed document 113 is read and parsed. Accordingly, every content item 115 in the feed is also read and parsed. This can be a lengthy process if the individual feed is large (i.e., includes a high number of content items). In other embodiments, an OPML file or other file format readable by scanning module 111a may be used. An OPML file may contain information, including the URL's or other addresses, of the electronic feed documents 113 of one or more feeds. Scanning module 111a reads the OPML file and steps through each feed represented therein. When stepping through an OPML file, the individual feeds and each content item 115 within the feed are read and parsed as described above.

In an operation 207, feeds that have been scanned/parsed are processed for storage into the database by one or more modules 111a-n (e.g., processing module 111b) of feed collection application 101. In some embodiments, processing includes normalizing each piece of information acquired regarding a feed and its content items 115 (i.e., all of the identified tags and their corresponding values) into a common format. This normalization may be necessary due to the disparate nature of different feeds. For example, in some instances, different feeds may use different types of identifiers for certain characteristics (e.g., the syntax used to identify the publication date of a content item in one feed may differ from that of other feeds). In another example, different feeds may represent the specific instances (i.e., values) of feed characteristics or content item characteristics in a different manner (e.g., the publication date of a content item may be represented in different formats—15 Jun. 2005 vs. Jun. 15, 2005 [used in the U.S.] vs. Jun. 6, 2005 [used in Europe], etc.). Other differences in identifiers for and the format for information relating to feeds or content items may exist. As described herein, normalization of this information enables feeds of disparate formats to be aggregated in a single repository such that these disparate feeds can be aggregated, indexed, filtered, and searched. Processing module 111b includes knowledge regarding the differences in how tags and values are represented. Processing module 111b uses this knowledge to recognize and account for the many differences during normalization.

In some embodiments, processing of feed or content item information in operation 107 may also include validating any scanned information (e.g., tags and values) for syntax and completeness. In particular, a check may be performed to verify that there is an address or link associated with each feed and each of its purported content items. No link within for the feed or its items implies that the feed is not well formed as defined by the W3C (World Wide Web Consortium).

Syntax and completeness checks may result in recoverable or fatal errors. Recoverable errors are defined as those where the application can resolve malformed or incomplete information and process the feed. Fatal errors are defined as those that cannot be resolved and result in the feed or content item not being processed.

After the feed and content item information is validated, processing of operation 207 may proceed to intelligently check the feed and content item information, including link information, to see if this information already is known to system 100. This includes determining whether information regarding a particular content item 115 is already stored within database 103. New information is stored in database 103. If any of the information is already known to the system, the system may intelligently check to see if any data is missing, perhaps not originally present, and store this missing data within the system.

Within database 103, content items 115 are associated with a unique URL or other address. Due to inconsistencies in standards, versions, and customizations found in RSS feed composition, the unique URL or address for content items is created from three different pieces of information. For example, processing module 111b may check for three main tags: (1) link, (2) GUID (Globally Unique Identifier), and (3) an enclosure URL. In some embodiments, the link tag takes precedence. In some embodiments, a regular link (e.g., feedberner:origlink) may be used to check the link tag so as to remive the need to go through a service (e.g., feedburner service) to find end content. If the link tag is not set, then the GUID is used. If neither link or GUID is set, such as heuristically found with many RSS feeds that contain podcasts, processing module 111b may use an enclosure URL associated with a media file contained within the content item. If none of these pieces of information are present, feed collecting application 101 may ignore the content item as incompatible with system 100.

Once a valid link with unique URL or other address is determined, feed collecting application 101 checks to see if that link in already stored in database 103. If the content item 115 is not already present, it is read and stored in database 103. In some embodiments, for efficiency, feed collecting application 101 may associate the link for a certain content item 1 15 with electronic feed document 1 13. This allows feed collecting application 101 to maintain a content item 115 as part of multiple feeds.

As described above, before storing information from a feed or content item 115 within database 103, the information is validated and normalized. For example, often a content item 115's publishing date does not exist or is in a “random” format. As such, in some embodiments, processing module 111b may take the date and time of the scan as the content item's publishing date. In some embodiments, a system specified string may be substituted for any information that is not present (e.g., if there is no author specified). In some embodiments, these system specified strings may be replaced manually during custom processing.

In some embodiments, operation 207 may also include custom processing, which can also be performed during initial feed gathering or updating. In some embodiments, custom processing includes the addition of additional tags to feeds or content items. For example, in some instances, tags that represent the content or category/topic of a feed or content item may be added. In some instances, the feed or content item may not be associated with such tags in its electronic feed document 113 (e.g., the content provider does not include such information in its electronic feed documents 113). In some instances, such information may be present but may be inadequate, inaccurate, unparsible, or otherwise be in need of additional tag information. Administrators, users or other entities may add the additional tags to a feed or content item. One or more modules 111a-n (e.g., interface module 111d) of feed collection application 101 may provide an interface for the association of additional tags and their corresponding values with feeds and/or content items by administrators, users 107, or other entities. These additional tags may be stored in database 103 and used for indexing, filtering, sorting, or otherwise used within system 100.

In some embodiments, custom processing may not be limited to the addition of content or category descriptive information. Other information may be added to feeds or content items. For example, certain keywords present within a control item 115 may be associated with the content item. In these instances, a keyword search may be performed using database 103 instead of by actually scanning the full content of content items. However, in some embodiments, an initial scan of a content (whether automated or manual) may be necessary to identify the keywords.

In some embodiments, custom processing may relate to enclosures. An enclosure is a file that typically provides rich media content such as, for example, an image file, a video file, an audio file, a flash file, or other media file. Custom processing of enclosures may include adding an enclosure tag to a feed or content item including or comprising an enclosure. The enclosure tag may provide media-specific information regarding any media that comprises the enclosure. Media-specific information may include, for example, the URL of the media file, the size of the media file, the media type, the media file format, and/or other information.

In some embodiments, custom processing may include extraction and storage of information regarding a media player for a specific content item (e.g., for certain audio or video enclosures). For example, many video and audio formats require their own custom players. It may be more efficient to extract the required information when processing the content item 115, rather than later when the content item is accessed. Other types of custom processing may also be performed.

In an operation 209, the processed data may then be stored in database 103 in a common format for further access using feed collection application 101.

Once feeds have been specified and acquired, all the feeds tracked by the application may be updated in an operation 211 according to a predefined time interval as part of a system scheduled task. The feeds to be updated (i.e., those identified in database 103) are read from database 103 and re-scanned according to the description above. In some embodiments, one or more modules 111a-n (e.g., scanning module 111a) of feed collection application 101 may intelligently detect whether there is any new information (e.g., new content items) within each feed. If there is no change to a feed's information, then that single feed need not be re-processed.

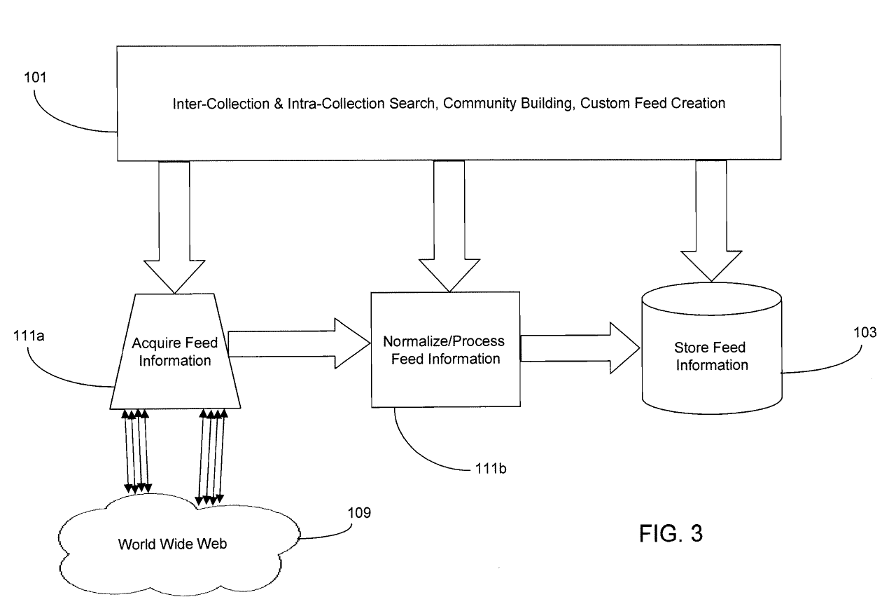

FIG. 3 illustrates an example of some of the components of system 100 as used to acquire, normalize, and store information regarding feeds and their content items as well as used to index, aggregate, and access feeds and their content items.

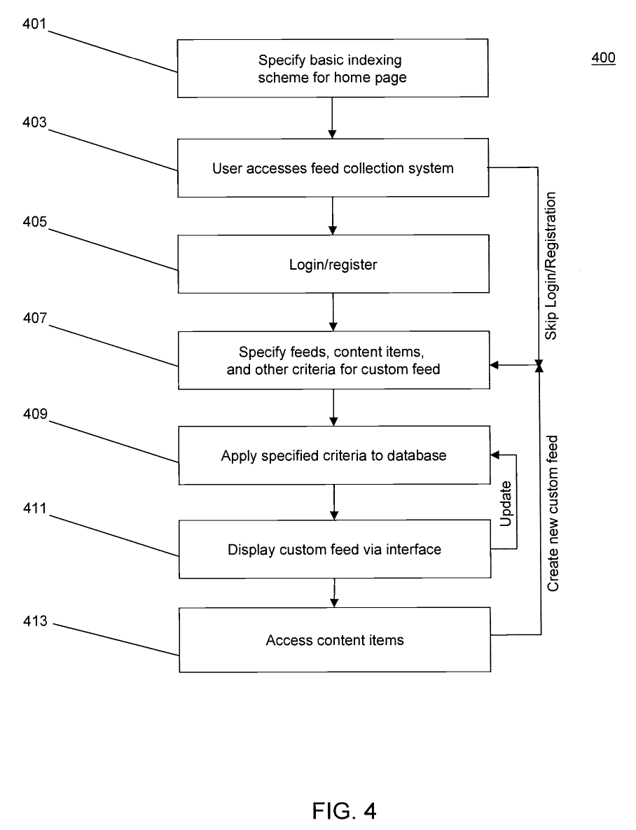

FIG. 4 illustrates process 400, an example of a process according to the invention for indexing, aggregating and/or accessing RSS feeds and their content items. In an operation 401, an administrator, user, or other entity may specify a certain indexing or organizational scheme for display of feeds and/or content item information stored within database 103. For example, interface module 111d of feed collection application 101 may provide a graphical user interface for display of the feed and content item information. In some embodiments, this graphical user interface may comprise a web site available via the internet. In some embodiments, this graphical user interface may be considered a “home page” for interaction with system 101. In some embodiments, an administrator may specify how feed and content item is displayed by the home page interface by specifying a display scheme.

In some embodiments, the home page interface may display a list of abbreviated content items 115 (e.g., titles and first line of text) grouped according to the specified indexing/categorization shceme. Each item in the list my be a hyperlink to the content items 115 listed. Thus, the application does not republish any content, but always refers back to the original source of information, e.g., the URL provided by the content provider 105. For example, the administrator may specify that feeds represented by the feed information stored in database 103 be organized and displayed by content provider, topic, and/or other characteristic. In another example, the administrator may specify that the content items 115 represented by the information stored in database 103 may be organized and displayed by originating feed, content provider, author, topic, publication date, and/or other characteristic. As such, users of system 100 may be able to browse through and access the feeds and content items 115 via this specified index.

One or more modules 111a-n (e.g., query/index module 111c) of feed collection application 101 may be used in conjunction with interface module 111d to access the feed and content item information from database 103 and present that information via the home page interface or other interface in the indexing scheme specified by the administrator.

In an operation 403, a user may access system 100 via network 109 and the home page interface or other interface of system 100 supported by interface module 111d. In some embodiments, system 100 may support access by multiple categories of users. For example, in some embodiments, system 100 may support access by registered and unregistered users. In these embodiments, the home page interface may, in an operation 405, direct users to a login/registration interface wherein a registered user may login using, for example, a username and password, or wherein an unregistered user may register with system 100. Registration with system 100 may include setting up a username for a user, a password for a user, a profile for a user, preferences for a user, and/or other activity.

In some embodiments, all users may be treated equally (e.g., there may be no user registration or only registered users may be granted access).

In an operation 407, a user may specify one or more specific feeds and/or content items 115 represented in database 103 to be included in a custom feed. In some embodiments, custom feeds may be constructed only by registered users. In some embodiments, any user may construct a custom feed.

In some embodiments, specifying feed and/or content items for a custom feed may include a user browsing the indexed feed and content item information (e.g., as displayed by the home page interface) and selecting the feeds or content items 115 to be included in the custom feed. In some embodiments, the user may alter the indexing/categorization scheme in which the feed/content items information is displayed so as to provide a different selection interface. For example, a user may want to construct a custom feed that includes only content items 115 from a certain author. If the current indexing scheme indexes the content items by content topic, the user may reorganize the content times 115 by author and make the desired selections for the custom feed.

In some embodiments, the user may perform a search of the feeds and/or content items 115 in database 103 to locate content items for a custom feed. In some embodiments, the content of the user's custom feed may be dictated by certain search terms (e.g., instead of searching database 103 and selecting from the search results, the feed is constructed from the search results, which may change as time passes and new items 115 and feeds are added to database 103).

In some embodiments, multiple characteristics may be used to index feed and content items and or to perform searches of database 103 (e.g., include content from feed A, and any feed or content items dealing with topic B or author C). In some embodiments, an index scheme or search may act as a filter to include some feeds/content items 115 and to exclude others (e.g., include all items by author X, but not those involving topic Y).

In some embodiments, some or all of the above described indexing and search capabilities may be supported by query/index module 111c of feed collection application 101.

In some embodiments, operation 407 may also include specifying other criteria for custom feeds such as, for example, an update time, whether the custom feed is public or private, and/or other criteria.

In an operation 409, the specified feeds, content items 115, and other criteria may be applied against database 103 to construct the custom feed. This operation may also utilize query/index module 111c to access and extract the results from database. In this way the various feed and content information is “aggregated” into a custom feed.

In an operation 411, an interface displaying the resultant custom feed may be constructed and presented to the user using interface module 111d. In some embodiments, the interface displaying the custom feed may include or utilize a feed reader (e.g., feed reader 117, a feed reader supported by interface module 111d, or another feed reader or interface).

In some embodiments, the custom feed may be updated at a predetermined time interval. In some embodiments, the custom feed may be updated upon user or administrator indication. Updating a custom feed may include applying the custom feed criteria against database 103, which may accrue new feeds and/or content items over time, some of which may match the custom feed criteria.

In an operation 413, the user may access the one or more content items 115 of the custom feed using, for example a feed reader. The custom feed includes the URLs or other addresses for each content item within the custom feed. The feed reader may access a content item using its URL or other address when a user indicates that access is desired (e.g., a mouse click on a hyperlink provided by the feed reader). In some embodiments, other users of system 100 may be able to access the custom feed. In some embodiments, only other registered users may be able to access the custom feed. In some embodiments, the user who created the custom feed may be able to specify who can access the custom feed.

In some embodiments, additional custom feeds may be created by returning to operation 407.

In some embodiments, users may personalize their interaction with system 100. For example, user may utilize custom feed creation to create “personalized topics.” One or more of these personalized topics may be associated with a user's account (i.e., for systems using registration) so as to create a personalized graphical user interface with system 100. The personalized graphical user interface displays a user's associated topics, including: personalized topics (i.e., the user's own custom feeds), other user's topics (custom feeds constructed by other users that the user has associated with his or her account), system/administrator created topics, simplified topics (e.g., all feeds and content items relating to “world politics”), or other categories of feeds and content items. In some embodiments, topics may be public and as such, all visitors to system 100 can view, search, and associate their accounts with the topic. In some embodiments, as described above, certain users (e.g., registered users) may have the option of having their personalized topics kept private.

In some embodiments, individual custom feeds may themselves be searched and/or used for custom feed creation (i.e., the creation of a given custom feed associates a tag with each feed or content item in database 103 such that the given custom feed tag may be another characteristic of the feed or content item 115 by which users can search).

In some embodiments, custom feeds created by users 107, administrators, or other persons may be available for subscription by users 107. For example, a user 107 may identify a custom feed of interest and may indicate that they desire to have the custom feed sent to their computer-implemented device. In some embodiments, subscribing users 107 may pay a fee to subscribe to a custom feed. In some embodiments, there may be no fee associated with subscribing to a custom feed.

In some embodiments, custom feeds or other feeds may be delivered to a computer-implemented device of a user 107. In some embodiments, delivery of feeds to the computer-implemented device of a user may include delivery of the associated feed and content item information stored in database 103 regarding the feed and its content items 115. In some embodiments, the computer-implemented device of the user 107 may access and/or store the content items 115 of the delivered feed so that the user 107 may access the content items 115 offline. As mentioned above, the computer-implemented devices of user 107 may include portable devices.

In some embodiments, feed collection application 101 may enable the creation of web community features as users join and add feeds to their topics. For example, some interfaces supported by interface module 111da, such as personalized interfaces of registered users, may include a list of friend's topics (e.g., shortcut to other user's topic areas). Other interfaces may include a recommendations engine (e.g., if you like this, then try that), popularity engines (e.g., most viewed topic, feeds, search terms, etc.), most used topics or characteristics, a topic creator classification (based on profile and usage information), and/or other features.

In some embodiments, system 100 may enable users 107 to interact with one another via various communication methods such as, for example, email, instant messenger (IM), voice communication, video, or other communication method. This interaction may enable users with similar interests to create group discussion, share information about custom feeds, or may enable other interaction.

In some embodiments, the invention may enable web advertising one or more graphical user interfaces supported by the invention such as, for example, on the “home page interface,” on registered user's personalized interface or topic pages, or on other graphical user interfaces of the invention. In some embodiments, the invention may enable an advertising revenue share model such to stimulate the creation of compelling topics and growth of site traffic. In some embodiments, advertisements may be targeted to a specific webpage supported by system 100. For example, if a feed or group of feeds pertaining to nutrition were displayed on a webpage of system 100, that webpage may include advertisements pertaining to health food. Other topics or advertisements may be used.

The invention may also include a computer readable medium having computer readable code thereon that instructs one or more processors to perform various features and functions of the invention such as, identifying/specifying feeds from which information is to be gathered, scanning feeds via their electronic feed documents to acquire information regarding feeds and content items of the feeds, normalizing the acquired feed information, storing the normalized feed information in a searchable database (e.g., database 103), associating custom characteristics or other information with the normalized feed information stored in database 103, querying or otherwise manipulating the normalized feed information, creating customized aggregated feeds, presenting the feed information to users 107 or other entities, or for performing any of the other various operations described in herein.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

What is claimed is:

1. A method for cataloguing content items hosted by electronic content providers, the method comprising:
accessing an electronic feed document that includes data regarding at least one content item provided by an electronic content provider;
parsing the data regarding the at least one content item into one or more tags, each tag having a corresponding value;
identifying, for each of the one or more tags, a characteristic of the at least one content item represented by the tag; and
storing the one or more tags and their corresponding values in a searchable format.

2. The method of claim 1, further comprising:
accessing a second electronic feed document that includes data regarding at least one additional content item provided by an electronic content provider, wherein the data regarding the at least one additional content item is in a different format from the data regarding the at least one content item;
parsing the data regarding the at least one additional content item into one or more tags, each tag having a corresponding value;
identifying, for each of the one or more tags, a characteristic of the at least one additional content item represented by the tag; and
storing the one or more tags and their corresponding values in the searchable format.

3. The method of claim 1, further comprising:
displaying a hyperlink to the at least one content item via a graphical user interface, wherein at least one characteristic of the at least one content item is displayed with the hyperlink.

4. The method of claim 1, wherein the electronic feed document also includes data regarding the electronic feed document that is parsable into one or more tags, each tag having a corresponding value.

5. The method of claim 1, wherein the electronic feed document comprises an RSS feed.

6. The method of claim 1, wherein the electronic feed document comprises an XML document.

7. The method of claim 1, wherein the electronic feed document comprises a document available on the World Wide Web.

8. The method of claim 7, wherein the electronic feed document is associated with a uniform resource locator (URL).

9. The method of claim 7, wherein the electronic feed document is associated with an IP address.

10. The method of claim 1, wherein the at least one content item comprises one or more of a text file, a video file, an audio file, an image file and, an HTML file.

11. The method of claim 1, wherein a characteristic of the at least one content item represented by a tag includes one or more of the title of the at least one content item, the publication date of the at least one content item, the publication time of the at least one content item, the author of the at least one content item, a summary of the at least one content item, a topic of the at least one content item, a first sentence of any text of the at least one content item, and an identity of an enclosures associated with the at least one content item.

12. The method of claim 1, wherein the at least one content items includes at least one media file and wherein a characteristic of the at least one content item represented by a tag includes one or more of a URL of the at least one media file, the size of the at least one media file, and the format of the at least one media file.

13. The method of claim 1, wherein the data regarding the at least one content item includes a uniform resource locator (URL) for the at least one content item.

14. The method of claim 1, further comprising:
associating one or more additional tags with the at least one electronic content item, each additional tag having a value, wherein the value of each additional tag is indicative of a characteristic of the at least one electronic content item; and
storing the one or more additional tags and their corresponding values in the searchable format.

15. The method of claim 14, wherein associating one or more additional tags with the at least one electronic content item further comprises scanning the at least one electronic content item to identify one or more characteristics.

16. The method of claim 15, wherein scanning the at least one electronic content item to identify one or more characteristics further comprises a human being examining the at least one content item to identify the one or more characteristics.

17. The method of claim 15, wherein scanning the at least one electronic content item to identify one or more characteristics further comprises an automatic scanner examining the at least one content item to identify the one or more characteristics.

18. A method of aggregating one or more electronic content items into a customized feed of content items, the method comprising:
receiving one or more custom parameters, each defining a value of a content item characteristic;
identifying one or more content items whose content item characteristics match the one or more custom parameters;
retrieving a location indicator for each of the one or more identified content items; and
providing a custom electronic feed document that includes at least the retrieved location indicators.

19. The method of claim 17, wherein the custom electronic feed document includes information regarding one or more characteristics of each of the identified content items.

20. The method of claim 17, further comprising:
updating the one or more content items whose content item characteristics match the one or more custom parameters at a predetermined interval;
retrieving a location indicator for each of the one or more identified content items; and
providing an updated custom electronic feed document that includes at least the retrieved location indicators.

21. A system for cataloguing content items hosted by electronic content providers, comprising:
a scanning module that scans an electronic feed document that includes data regarding at least one content item provided by an electronic content provider and parses the data regarding the at least one content item into one or more tags, each tag having a corresponding value;
a processing module that identifies, for each of the one or more tags, a characteristic of the at least one content item represented by the tag; and
a database that stores the one or more tags and their corresponding values in a searchable format.

22. The system of claim 21, wherein the scanning module further accesses a second electronic feed document that includes data regarding at least one additional content item provided by an electronic content provider, wherein the data regarding the at least one additional content item is in a different format from the data regarding the at least one content item and parses the data regarding the at least one additional content item into one or more tags, each tag having a corresponding value,
wherein the processing module identifies, for each of the one or more tags, a characteristic of the at least one additional content item represented by the tag, and
wherein the database stores the one or more tags and their corresponding values in the searchable format.

23. The system of claim 21, wherein the processing module further associates one or more additional tags with the at least one electronic content item, each additional tag having a value, wherein the value of each additional tag is indicative of a characteristic of the at least one electronic content item, and
wherein the database stores the one or more additional tags and their corresponding values in the searchable format.

24. A system for aggregating one or more electronic content items into a customized feed of content items, the method comprising:
an interface module that receives one or more custom parameters, each defining a value of a content item characteristic;
a query module that identifies one or more content items whose content item characteristics match the one or more custom parameters and that retrieves a location indicator for each of the one or more identified content items; and
wherein the interface module provides a custom electronic feed document that includes at least the retrieved location indicators.
